(19) United States
(12) Patent Application Publication
(10) Pub. No.: US 2016/0299903 A1
(43) Pub. Date: Oct. 13, 2016

(54) PATH ANALYSIS METHOD AND APPARATUS

(71) Applicant: BEIJING GRIDSUM TECHNOLOGY CO. LTD., Beijing (CN)

(72) Inventors: Chao HONG, Beijing (CN); Jibin YANG, Beijing (CN)

(73) Assignee: Beijing Gridsum Technology Co., Ltd

(21) Appl. No.: 15/037,783

(22) PCT Filed: Oct. 30, 2014
(86) PCT No.: PCT/CN2014/089936

§ 371 Date: May 19, 2016

(30) Foreign Application Priority Data
Nov. 19, 2013 (CN) 201310585827.9

(51) Int. Cl. G06F 17/30

(52) U.S. Cl. CPC G06F 17/3056; G06F 17/30592

(57) ABSTRACT

The disclosure discloses a path analysis method and apparatus. The method includes that: an access table is established, information about a plurality of paths accessed by a user and saved according to a path access order of the user being saved in each entry in the access table; the access table is searched for an entry containing a predetermined path; and path analysis relevant to the predetermined path is carried out according to the entry. By means of the disclosure, the problem in the relevant art of low execution efficiency caused by the fact that path analysis is carried out by performing self-connection on a path access table in a data warehouse is solved, thereby improving the efficiency of path analysis.

### TECHNICAL FIELD

The disclosure relates to the field of data analysis, and in particular to a path analysis method and apparatus.

### BACKGROUND

On-Line Analytical Processing (OLAP for short) is a multi-dimensional information-shared and specific problem-oriented rapid software technology for on-line data access and analysis. Rapid, stable, consistent and interactive access is carried out in multiple possible information observation forms by means of the OLAP, and management decision makers are allowed to deeply observe data. Decision data is multi-dimensional data which is the main content of a decision. The OLAP is specially designed to support complicated analysis operations, focuses on decision supporting of decision makers and top managers, can rapidly and flexibly carry out complicated query processing on a great data volume according to requirements of an analyst, and provides a query result to the decision maker in a visual and understandable form in order that they accurately master operation situations of an enterprise (company), know requirements of an object and make a correct plan.

Relevant information about OLAP can be further seen on descriptions of http://baike.baidu.com/view/22068.htm?fromId=57810 in Baidu Baike, and will not be described in detail.

Path navigation: a path is a website access path chain of a user. If the user accesses a page A and a page B successively, returns to the page A and then quits the page A, the path is shown as A→B→A. The path navigation refers to displaying of an access path of the user via an interface.

In the OLAP, the path navigation mainly includes:

Previous page analysis: selecting a certain Uniform Resource Locator (URL for short) path, and checking the distribution condition of a previous page with respect to this page accessed by all users; and

Subsequent page analysis: selecting a certain URL path, and checking the distribution condition of a subsequent page with respect to this page accessed by all the users.

However, in the relevant art, a method for obtaining previous and next pages of a specific URL by querying a data warehouse and carrying out statistical analysis on relevant page indexes (such as an access count and a stay duration), instead of an OLAP implementation mode, is adopted.

A path navigation analysis method based on a traditional data warehouse in the relevant art adopts technical solutions as follows.

A path access table is established, and a column, a VisitorKey, a SessionID, a PageKey and a NextPageKey are contained in the path access table.

By taking the previous page analysis method in the relevant art as an example, the distribution condition of a next page is searched by means of the NextPageKey according to the PageKey referring to a selected page.

By adoption of the above said technical solutions, if it is necessary to carry out multi-level analysis namely to analyze the distribution condition of a next page of a specific subsequent page with respect to a certain page, table connection operation is needed; and moreover, the frequency of the table connection operation depends on the level number of analysis. In the course of research, the inventor discovers that during the analysis of a multi-level path, the execution efficiency will be very low due to the fact that self-connection operation needs to be frequently executed.

An effective solution is not proposed currently for the problem in the relevant art of low execution efficiency caused by the fact that path analysis is carried out by performing self-connection on the path access table in the data warehouse.

### SUMMARY

The disclosure provides a path analysis method and apparatus, which are intended to at least solve the problem in the relevant art.

According to one aspect of the disclosure, a path analysis method is provided, which may include that: an access table is established, information about a plurality of paths accessed by a user and saved according to a path access order of the user being saved in each entry in the access table; the access table is searched for a first entry, the first entry being an entry containing a predetermined path; and path analysis relevant to the predetermined path is carried out according to the first entry.

Preferably, the step that the access table is established may include that: an original access table saved in a data warehouse is acquired, information about one path accessed by one user being saved in each entry in the original access table; and the access table is established according to the original access table.

Preferably, under the condition that path analysis relevant to the predetermined path is previous analysis for the predetermined path, the step that path analysis relevant to the predetermined path is carried out according to the first entry may include that: information about a path accessed by the user before accessing the predetermined path in the entry is determined; and the distribution condition of the path accessed by the user before accessing the predetermined path is determined according to the information about the path accessed by the user before accessing the predetermined path.

Preferably, under the condition that the previous analysis is N-level previous analysis, the step that path analysis relevant to the predetermined path is carried out according to the first entry may include that: information about N paths accessed by the user before accessing the predetermined path in the entry is determined; and the distribution conditions of the N paths accessed by the user before accessing the predetermined path are determined according to the information about the N paths accessed by the user before accessing the predetermined path, N being a positive integer.

Preferably, under the condition that path analysis relevant to the predetermined path is subsequent analysis for the predetermined path, the step that path analysis relevant to the predetermined path is carried out according to the first entry may include that: information about a path accessed by the user after accessing the predetermined path in the entry is determined; and the distribution condition of the path accessed by the user after accessing the predetermined path is determined according to the information about the path accessed by the user after accessing the predetermined path.

Preferably, under the condition that the subsequent analysis is M-level subsequent analysis, the step that path analysis relevant to the predetermined path is carried out according to the first entry may include that: information about M paths accessed by the user after accessing the predetermined path in the entry is determined; and the distribution conditions of the M paths accessed by the user after accessing the predetermined path are determined according to the information about the M paths accessed by the user after accessing the predetermined path, M being a positive integer.

According to another aspect of the disclosure, a path analysis apparatus is also provided, which may include: an establishment module, configured to establish an access table, information about a plurality of paths accessed by a user and saved according to a path access order of the user being saved in each entry in the access table; a searching module, configured to search the access table for a first entry, the first entry being an entry containing a predetermined path; and an analysis module, configured to carry out path analysis relevant to the predetermined path according to the first entry.

Preferably, the establishment module may include: an acquisition unit, configured to acquire an original access table saved in a data warehouse, information about one path accessed by one user being saved in each entry in the original access table; and an establishment unit, configured to establish the access table according to the original access table.

Preferably, the analysis module may include: a first determination unit, configured to determine information about a path accessed by the user before accessing the predetermined path in the first entry; and a second determination unit, configured to determine the distribution condition of the path accessed by the user before accessing the predetermined path according to the information about the path accessed by the user before accessing the predetermined path.

Preferably, the analysis module may include: a third determination unit, configured to determine information about a path accessed by the user after accessing the predetermined path in the first entry; and a fourth determination unit, configured to determine the distribution condition of the path accessed by the user after accessing the predetermined path according to the information about the path accessed by the user after accessing the predetermined path.

According to another aspect of the disclosure, a path analysis system is also provided, which may include: a data warehouse and a path analysis apparatus, wherein the data warehouse is configured to establish an access table, information about a plurality of paths accessed by a user and saved according to a path access order of the user being saved in each entry in the access table; and the path analysis apparatus is configured to search the access table for a first entry, the first entry being an entry containing a predetermined path, and further configured to carry out path analysis relevant to the predetermined path according to the first entry.

By means of the disclosure, the access table is established, wherein the information about a plurality of paths accessed by the user and saved according to the path access order of the user is saved in each entry in the access table; the access table is searched for the entry containing the predetermined path; and path analysis relevant to the predetermined path is carried out according to the entry. Thus, the problem in the relevant art of low execution efficiency caused by the fact that path analysis is carried out by performing self-connection on a path access table in a data warehouse is solved, thereby improving the efficiency of path analysis.

### BRIEF DESCRIPTION OF THE DRAWINGS

The drawings described here are intended to provide further understanding of the disclosure, and form a part of the disclosure. The schematic embodiments and descriptions of the disclosure are intended to explain the disclosure, and do not form improper limits to the disclosure. In the drawings:

FIG. 1 is a flow diagram of a path analysis method according to an embodiment of the disclosure;

FIG. 2 is a structural diagram of a path analysis apparatus according to an embodiment of the disclosure;

FIG. 3 is a structural diagram of a path analysis system according to an embodiment of the disclosure;

FIG. 4 is a diagram of a path navigation result according to a preferred embodiment of the disclosure;

FIG. 5 is an operation diagram of a path analysis system according to a preferred embodiment of the disclosure; and

FIG. 6 is a diagram of a path navigation analysis result according to a preferred embodiment of the disclosure.

### DETAILED DESCRIPTION OF THE EMBODIMENTS

It is important to note that the embodiments of the disclosure and the characteristics in the embodiments can be combined under the condition of no conflicts. The disclosure is described below with reference to the drawings and the embodiments in detail.

The steps shown in the flowchart of the drawings can be executed in a computer system including, for example, a set of computer executable instructions. Moreover, although a logical sequence is shown in the flowchart, the shown or described steps can be executed in a sequence different from the sequence here under certain conditions.

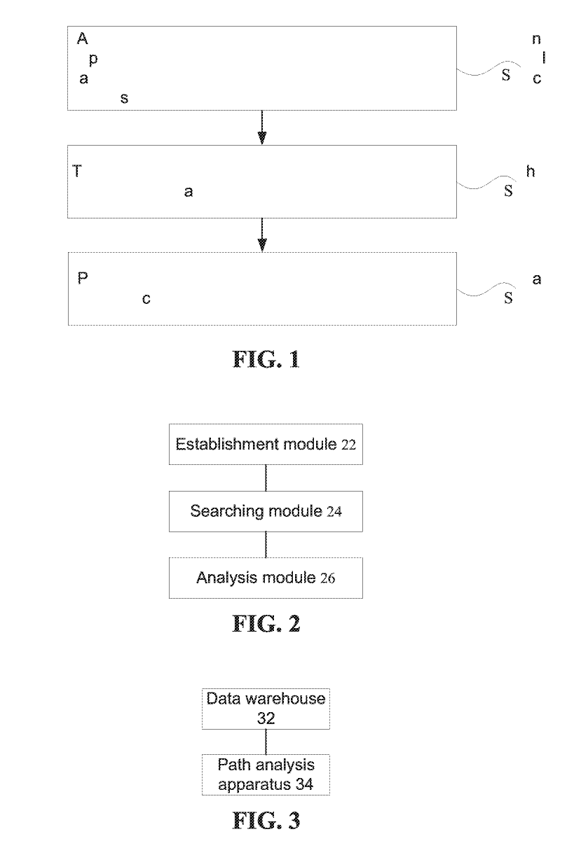

An embodiment provides a path analysis method. FIG. 1 is a flow diagram of a path analysis method according to an embodiment of the disclosure. As shown in FIG. 1, the flow includes the steps as follows.

Step S102: An access table is established, information about a plurality of paths accessed by a user and saved according to a path access order of the user being saved in each entry in the access table.

Step S104: The access table is searched for an entry containing a predetermined path.

In the embodiment of the disclosure, the predetermined path is a path required to be analyzed, and pre-settings can be made according to the path analysis requirement.

Step S106: Path analysis relevant to the predetermined path is carried out according to the entry.

By means of the steps, the access table in which the information about a plurality of paths accessed by the user and saved according to the path access order of the user is saved in each entry is adopted, so that it is only necessary to search the established access table for the entry containing the predetermined path under the condition that path analysis relevant to a characteristic path is carried out, and it is no longer necessary to perform table self-connection. Compared with the relevant art in which the execution efficiency is lowered due to self-connection operation on data in a data warehouse during analysis, the solution provided by the embodiment solves the problem of low execution efficiency caused by the fact that path analysis is carried out by performing self-connection on a path access table in the data warehouse, thereby improving the efficiency of path analysis.

Preferably, the access table established in Step S102 is generated from an original access table saved in the data warehouse and can be generated by the data warehouse or other apparatuses, generation time for the access table can be within an idle time period of a system, and a minimum requirement is to ensure the timeliness of path data updating. For example, the original access table saved in the data warehouse is acquired, and the access table is established according to the original access table, wherein information about a path accessed by a user is saved in each entry in the original access table. By means of the processing, processing time is transferred to idle time of the system, so that the analysis efficiency of path analysis is improved.

Preferably, under the condition that path analysis relevant to the predetermined path is previous analysis for the predetermined path, when path analysis relevant to the predetermined path is carried out, information about a path accessed by the user before accessing the predetermined path in the entry is determined; and then the distribution condition of the path accessed by the user before accessing the predetermined path is determined according to the determined information, such as the total distribution condition of a page view count, the time law-based distribution condition of the page view count, the distribution condition of a page view duration and the time law-based distribution condition of the page view duration.

Preferably, under the condition that the previous analysis is N-level previous analysis, when path analysis relevant to the predetermined path is carried out, information about N paths accessed by the user before accessing the predetermined path in the entry is determined; and then the distribution conditions of the N paths accessed by the user before accessing the predetermined path are determined according to the determined information about the N paths, N being a positive integer.

Preferably, under the condition that path analysis relevant to the predetermined path is subsequent analysis for the predetermined path, when path analysis relevant to the predetermined path is carried out, information about a path accessed by the user after accessing the predetermined path in the entry is determined; and then the distribution condition of the path accessed by the user after accessing the predetermined path is determined according to the determined information.

Preferably, under the condition that the previous analysis is M-level subsequent analysis, when path analysis relevant to the predetermined path is carried out, information about M paths accessed by the user after accessing the predetermined path in the entry is determined; and then the distribution conditions of the M paths accessed by the user after accessing the predetermined path are determined according to the determined information about the M paths, M being a positive integer.

An embodiment also provides a path analysis apparatus. The apparatus is configured to realize the path analysis method. The realization of functions in the apparatus embodiment has been described in detail in the method embodiment, and will not be repeated herein.

FIG. 2 is a structural diagram of a path analysis apparatus according to an embodiment of the disclosure. As shown in FIG. 2, the apparatus includes: an establishment module 22, a searching module 24 and an analysis module 26, wherein the establishment module 22 is configured to establish an access table, information about a plurality of paths accessed by a user and saved according to a path access order of the user being saved in each entry in the access table; the searching module 24 can be coupled to the establishment module 22 and is configured to search the access table for an entry containing a predetermined path; and the analysis module 26 can be coupled to the searching module 24 and is configured to carry out path analysis relevant to the predetermined path according to the entry.

The modules and units involved in the embodiment of the disclosure can be realized in a software form or a hardware form. The modules and the units described in the embodiment can also be arranged in a processor. For example, it can be described as that: a processor includes the establishment module 22, the searching module 24 and the analysis module 26, wherein the names of these modules do not form limitations to themselves under certain conditions. For example, the establishment module can also be described as ‘a module configured to establish an access table’.

Preferably, the establishment module 22 includes: an acquisition unit 222, coupled to a data warehouse and configured to acquire an original access table saved in the data warehouse, information about a path accessed by a user being saved in each entry in the original access table; and an establishment unit 224, coupled to the acquisition unit 222 and configured to establish the access table according to the original access table.

Preferably, the analysis module 26 includes: a first determination unit 262, configured to determine information about a path accessed by the user before accessing the predetermined path in the entry; and a second determination unit 264, capable of being coupled to the first determination unit 262, and configured to determine the distribution condition of the path accessed by the user before accessing the predetermined path according to the information about the path accessed by the user before accessing the predetermined path.

Preferably, the first determination unit 262 is further configured to determine information about N paths accessed by the user before accessing the predetermined path in the entry; and the second determination unit is further configured to determine the distribution condition of the N paths accessed by the user before accessing the predetermined path according to the information about the N paths accessed by the user before accessing the predetermined path.

Preferably, the analysis module 26 includes: a third determination unit 266, configured to determine information about a path accessed by the user after accessing the predetermined path in the entry; and a fourth determination unit 268, coupled to the third determination unit 266 and configured to determine the distribution condition of the path accessed by the user after accessing the predetermined path according to the information about the path accessed by the user after accessing the predetermined path.

Preferably, the third determination unit 266 is further configured to determine information about M paths accessed by the user after accessing the predetermined path in the entry; and the fourth determination unit 268 is further configured to determine the distribution condition of the M paths accessed by the user after accessing the predetermined path according to the information about the M paths accessed by the user after accessing the predetermined path.

An embodiment also provides a path analysis system. The system is configured to realize the path analysis method. The realization of functions in the system embodiment has been described in detail in the method embodiment, can be explained in the system embodiment with reference to the descriptions, and will not be repeated herein.

FIG. 3 is a structural diagram of a path analysis system according to an embodiment of the disclosure. As shown in FIG. 3, the system includes: a data warehouse 32 and a path analysis apparatus 34, wherein the data warehouse 32 is configured to establish an access table, information about a plurality of paths accessed by a user and saved according to a path access order of the user being saved in each entry in the access table; and the path analysis apparatus is configured to search the access table for an entry containing a predetermined path, and carry out path analysis relevant to the predetermined path according to the entry.

From the descriptions, it can be seen that: in the system embodiment, an establishment process of the access table is transplanted to the data warehouse to be processed. It can be understood that the beneficial effects of the disclosure can be achieved regardless of processing in the data warehouse or the path analysis apparatus, and processing shall fall within the protection scope of the disclosure.

Descriptions and explanations are performed below with reference to a preferred embodiment.

The preferred embodiment provides an OLAP efficient path navigation analysis solution so as to solve the problems in the relevant art that analysis query may be carried out only in a data warehouse instead of OLAP, the performance is relatively low and self-connection operation on a page table is needed in navigation each time. An OLAP efficient path navigation analysis apparatus provided in the preferred embodiment is efficient in performance due to the inexistence of table self-connection operation.

In the preferred embodiment, an N-level efficient mode is adopted, N refers to a random positive integer, and if the N is 1, the N-level efficient mode can be equivalent to a traditional implementation mode. The setting is intended to prevent table self-connection query operation similar to the traditional mode from occurring in the OLAP, and query time is obtained by means of a storage space.

The preferred embodiment includes the steps as follows.

Step S11: An access table is established in a data warehouse, the access table containing a VisitorKey (a unique identifier of a visitor), a SessionID (a unique identifier of a session), a Page1Key (a first path on a path chain), a Page2Key, . . . , and a PageNKey, a row of records representing an access path of a user, and subsequent extended N columns representing subsequent N paths of this path.

Step S12: A quit default value is defined for each PageKey, the default value identifying that the user quits a website.

Step S13: A value is assigned to each path column from page2Key to PageNKey to form subsequent N path information starting from each path point, and the value of a subsequent quitting path is set as a defined default value.

Step S14: N page dimensions from Page1Key to PageNKey are added during design in OLAP, and are associated with Page1Key to PageNKey in the access table via corresponding keys.

Step S15: By means of the settings, the following analysis can be conveniently carried out:

previous analysis: checking the distribution condition of a previous page path Page1Key with respect to a specific page Page2Key;

subsequent analysis: checking the distribution condition of a subsequent page path Page2Key with respect to a specific page Page1Key;

multi-level previous analysis: within N levels, directly analyzing previous N levels through extended PageNKey to Page1Key without table connection, and making previous path analysis, exceeding N levels, equivalent to a table connection mode in traditional implementation; and

multi-level subsequent analysis: within N levels, directly analyzing subsequent N levels through extended Page1Key to PageNKey without table connection, and making subsequent path analysis, exceeding N levels, equivalent to a table connection mode in traditional implementation.

The preferred embodiment is explained below with reference to a specific example.

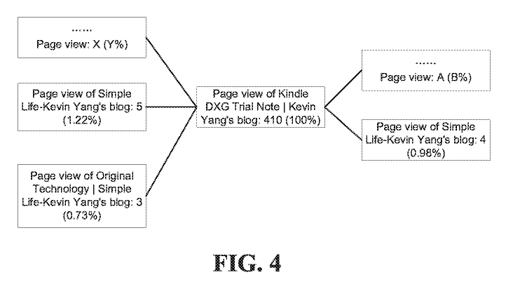

FIG. 4 is a diagram of a path navigation result according to a preferred embodiment of the disclosure. As shown in FIG. 4, a previous page and a subsequent page with respect to a selected random page can be checked, namely it can be checked where the page comes and where it goes. Multi-level analysis (namely multi-level previous analysis or multi-level subsequent analysis) refers to analysis where it goes successively. N-level analysis or infinite-level can be supported by means of the solution of the preferred embodiment.

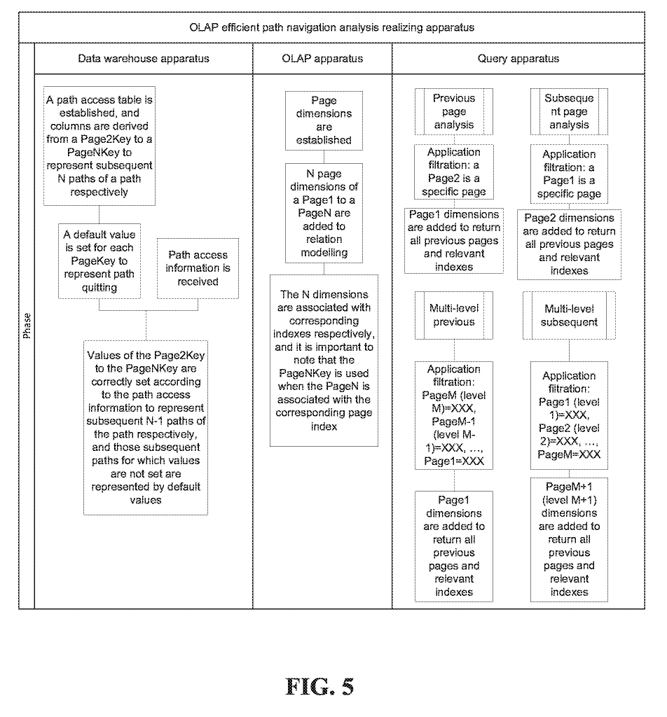

For example, FIG. 5 is an operation diagram of a path analysis system according to a preferred embodiment of the disclosure. As shown in FIG. 5, in an adopted solution of the preferred embodiment, path navigation analysis is completed by means of a data warehouse apparatus, an OLAP apparatus and a query apparatus.

Wherein, in the data warehouse apparatus,

In Step S11, a table is established in a data warehouse, the table containing a VisitorKey (a unique identifier of a visitor), a SessionID (a unique identifier of a session), a Page1Key (a first path on a path chain), a Page2Key, . . . , and a PageNKey. For example,

an original page path order is obtained, and it is assumed to be p1→p1→p1 as shown in Table 1.

TABLE 1

| VisitorKey | SessionID | PageKey | AccessOrder |
|---|---|---|---|
| Vid1 | Sid1 | p1 | 1 |
| Vid1 | Sid1 | p2 | 2 |
| Vid1 | Sid1 | p1 | 3 |

Values are assigned to subsequent n-level paths of each path according to a path access order in source table data (namely the original page path order) respectively. It is assumed that a quit default value is ‘−’ as shown in Table 2.

TABLE 2

| Visitor- | Session- | | | | | |
|---|---|---|---|---|---|---|
| Key | ID | Page1Key | Page2Key | Page3Key | . . . | PageNKey |
| Vid1 | Sid1 | p1 | p2 | p1 | — | — |
| Vid1 | Sid1 | p2 | p1 | — | — | — |
| Vid1 | Sid1 | p1 | — | — | — | — |

In the OLAP apparatus,

N page dimensions from Page1Key to PageNKey are added during design, and are associated with Page1Key to PageNKey in an access path table via corresponding keys, wherein each Page dimension is associated with an index group via the corresponding PageXKey (X represents 1 to N).

In the query apparatus,

The subsequent analysis is taken as an example in the preferred embodiment, and the previous analysis and the multi-level analysis can be explained with reference to the example.

Analysis of a subsequent page with respect to a page P2:

a data row is filtered in case of Page1Key=P2, and as shown in Table 3, there is only a row of remaining result sets (there may be multiple rows in some other embodiments, but only the simplest example is adopted for explanations herein). Then values of all Page2Keys are selected as subsequent pages, namely p1, with respect to all pages in case of Page1Key=P2.

TABLE 3

| Visitor- | Session- | | | | | |
|---|---|---|---|---|---|---|
| Key | ID | Page1Key | Page2Key | Page3Key | . . . | PageNKey |
| Vid1 | Sid1 | p2 | p1 | — | — | — |

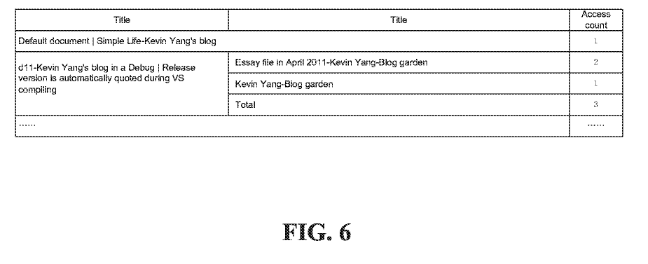

FIG. 6 is a diagram of a path navigation analysis result according to a preferred embodiment of the disclosure. As shown in FIG. 6, due to the fact that a page dimension is used in OLAP modelling, member dimension titles here are the same, a previous title represents a title corresponding to a Page1Key, and a subsequent title represents a title corresponding to a Page2Key. Thus, from one of pages to all subsequent pages and other indexes (such as a page view) corresponding thereto can be clearly seen.

By means of the descriptions, N columns are derived in a data warehouse in the preferred embodiment to represent a subsequent path of each path, so that table self-connection occurring during N-level path navigation or many-to-many association operation in OLAP is avoided to improve the performance; by adding the same dimension for many times in the OLAP, Page1 to PageN are associated with PageKeys of corresponding tables of the data warehouse respectively; during previous analysis, it is only necessary to query Page1 which satisfies a certain condition of Page2; during subsequent analysis, it is only necessary to query Page2 which satisfies a certain condition of Page1; during multi-level (M-level, ranging from 1 to N) previous analysis, it is only necessary to query Page1 which satisfies a post-condition on a selected path from PageM to Page2; and during multi-level (M-level, ranging from 1 to N) subsequent analysis, it is only necessary to query PageM which satisfies a certain condition on a path from Page1 to PageM-1. The analysis process can be obtained by query for one time, Input Output (IO) will occur for one time during the query, and many-to-many operation similar to table connection of the data warehouse can be avoided, thereby improving the execution efficiency.

Obviously, those skilled in the art should understand that all modules or all steps in the disclosure can be realized by using a general calculation apparatus, can be centralized on a single calculation apparatus or can be distributed on a network composed of a plurality of calculation apparatuses.

Optionally, they can be realized by using executable program codes of the calculation apparatuses. Thus, they can be stored in a storage apparatus and executed by the calculation apparatuses, or they are manufactured into each integrated circuit module respectively, or a plurality of modules or steps therein are manufactured into a single integrated circuit module. Thus, the disclosure is not limited to a combination of any specific hardware and software.

The above is only the preferred embodiments of the disclosure, and is not intended to limit the invention. There can be various modifications and variations in the disclosure for those skilled in the art. Any modifications, equivalent replacements, improvements and the like within the spirit and principle of the disclosure shall fall within the protection scope of the invention.

1. A path analysis method, comprising:
establishing an access table, information about a plurality of paths accessed by a user and saved according to a path access order of the user being saved in each entry in the access table;
searching the access table for a first entry, the first entry being an entry containing a predetermined path; and
carrying out path analysis relevant to the predetermined path according to the first entry.

2. The method according to claim 1, wherein establishing the access table comprises:
acquiring an original access table saved in a data warehouse, information about one path accessed by one user being saved in each entry in the original access table; and
establishing the access table according to the original access table.

3. The method according to claim 1, wherein under the condition that path analysis relevant to the predetermined path is previous analysis for the predetermined path, carrying out path analysis relevant to the predetermined path according to the first entry comprises:
determining information about a path accessed by the user before accessing the predetermined path in the first entry; and
determining the distribution condition of the path accessed by the user before accessing the predetermined path according to the information about the path accessed by the user before accessing the predetermined path.

4. The method according to claim 3, wherein under the condition that the previous analysis is N-level previous analysis, carrying out path analysis relevant to the predetermined path according to the first entry comprises:
determining information about N paths accessed by the user before accessing the predetermined path in the first entry; and
determining the distribution conditions of the N paths accessed by the user before accessing the predetermined path according to the information about the N paths accessed by the user before accessing the predetermined path, N being a positive integer.

5. The method according to claim 1, wherein under the condition that path analysis relevant to the predetermined path is subsequent analysis for the predetermined path, carrying out path analysis relevant to the predetermined path according to the first entry comprises:
determining information about a path accessed by the user after accessing the predetermined path in the first entry; and
determining the distribution condition of the path accessed by the user after accessing the predetermined path according to the information about the path accessed by the user after accessing the predetermined path.

6. The method according to claim 5, wherein under the condition that the subsequent analysis is M-level subsequent analysis, carrying out path analysis relevant to the predetermined path according to the first entry comprises:
determining information about M paths accessed by the user after accessing the predetermined path in the first entry; and
determining the distribution conditions of the M paths accessed by the user after accessing the predetermined path according to the information about the M paths accessed by the user after accessing the predetermined path, M being a positive integer.

7. A path analysis apparatus, comprising:
an establishment module, configured to establish an access table, information about a plurality of paths accessed by a user and saved according to a path access order of the user being saved in each entry in the access table;
a searching module, configured to search the access table for a first entry, the first entry being an entry containing a predetermined path; and
an analysis module, configured to carry out path analysis relevant to the predetermined path according to the first entry.

8. The apparatus according to claim 7, wherein the establishment module comprises:
an acquisition unit, configured to acquire an original access table saved in a data warehouse, information about one path accessed by one user being saved in each entry in the original access table; and
an establishment unit, configured to establish the access table according to the original access table.

9. The apparatus according to claim 7, wherein the analysis module comprises:
a first determination unit, configured to determine information about a path accessed by the user before accessing the predetermined path in the first entry; and
a second determination unit, configured to determine the distribution condition of the path accessed by the user before accessing the predetermined path according to the information about the path accessed by the user before accessing the predetermined path.

10. The apparatus according to claim 7, wherein the analysis module comprises:
a third determination unit, configured to determine information about a path accessed by the user after accessing the predetermined path in the entry; and
a fourth determination unit, configured to determine the distribution condition of the path accessed by the user after accessing the predetermined path according to the information about the path accessed by the user after accessing the predetermined path.

11. A path analysis system, comprising: a data warehouse and a path analysis apparatus, wherein
the data warehouse is configured to establish an access table, information about a plurality of paths accessed by a user and saved according to a path access order of the user being saved in each entry in the access table; and
the path analysis apparatus is configured to search the access table for a first entry, the first entry being an entry containing a predetermined path, and further configured to carry out path analysis relevant to the predetermined path according to the first entry.

12. The method according to claim 2, wherein under the condition that path analysis relevant to the predetermined path is previous analysis for the predetermined path, carrying out path analysis relevant to the predetermined path according to the first entry comprises:
determining information about a path accessed by the user before accessing the predetermined path in the first entry; and
determining the distribution condition of the path accessed by the user before accessing the predetermined path according to the information about the path accessed by the user before accessing the predetermined path.

13. The method according to claim 2, wherein under the condition that path analysis relevant to the predetermined path is subsequent analysis for the predetermined path, carrying out path analysis relevant to the predetermined path according to the first entry comprises:
determining information about a path accessed by the user after accessing the predetermined path in the first entry; and
determining the distribution condition of the path accessed by the user after accessing the predetermined path according to the information about the path accessed by the user after accessing the predetermined path.

14. The apparatus according to claim 8, wherein the analysis module comprises:
a first determination unit, configured to determine information about a path accessed by the user before accessing the predetermined path in the first entry; and
a second determination unit, configured to determine the distribution condition of the path accessed by the user before accessing the predetermined path according to the information about the path accessed by the user before accessing the predetermined path.

15. The apparatus according to claim 8, wherein the analysis module comprises:
a third determination unit, configured to determine information about a path accessed by the user after accessing the predetermined path in the entry; and
a fourth determination unit, configured to determine the distribution condition of the path accessed by the user after accessing the predetermined path according to the information about the path accessed by the user after accessing the predetermined path.
